(19) United States
(12) Patent Application Publication
(10) Pub. No.: US 2007/0260034 A1
(43) Pub. Date: Nov. 8, 2007

(54) Thermoplastic copolyester and polyester container made of the same

(75) Inventor: Zo-Chun Jen, Taipei (TW)

Correspondence Address: BACON & THOMAS, PLLC, 625 SLATERS LANE, FOURTH FLOOR, ALEXANDRIA, VA, 22314, US

(73) Assignee: NAN YA PLASTICS CORPORATION, Taipei (TW)

(21) Appl. No.: 11/797,399

(22) Filed: May 3, 2007

(30) Foreign Application Priority Data
May 4, 2006 (TW) 095115863

(51) Int. Cl. C08G 63/02

(52) U.S. Cl. 528/272

(57) ABSTRACT

A thermoplastic copolyester having inherent viscosity (IV) of 0.76˜0.90 dl/g comprises bis-hydroxyethyl terephthalate, 0.8˜3.0 mole % of component containing naphthalene ring structure and 1.0˜2.0 mole % of diethylene glycol based on the copolyester; particularly, the copolyester is suitable for producing a kind of polyester container capable to sustain a hot bottling temperature at least higher than 82□ and pass a high temperature pasteurization test successfully.

### BACKGROUND OF THE INVENTION

1. Field of the Invention

The invention relates to a thermoplastic copolyester containing little amount of naphthalene ring structure and limited amount of diethylene glycol, particularly the copolyester suitable for producing a kind of polyester container capable to sustain a hot bottling temperature at least higher than 82□.

2. Description of the Prior Art

Normally thermoplastic copolyester (hereinafter referred to as copolyester) containing naphthalene ring structure has a glass-transition temperature higher than that of the conventional polyester material. However, this type of copolyester must contain higher amount of naphthalene ring structure to achieve the property of higher heat resistance, this has been known well by those skilled in the art such as the copolyester disclosed in the U.S. Pat. No. 6,551,675 which contains 5-15 mole % of naphthalene ring structure.

Particularly, the polyester container, if made of the copolyester material containing naphthalene ring structure, can possess higher heat resistance and can successfully pass high temperature pasteurization test. These were also the conventional know-how and technical knowledge already known by those skilled in the art in the related field such as the copolyester material containing 3 mole % or 5 mole % of naphthalene ring structure as disclosed in U.S. Pat. No. 6,284,920, and the polyester container made of this kind of copolyester can successfully pass high temperature pasteurization test.

The conventional process for producing copolyester as mentioned above includes DMT process or PTA process. In DMT process 2,6-naphthalenedicarboxylate (2,6-NDC) is employed as raw material, and the copolyester containing naphthalene ring structure is obtained through ester exchange reaction. Since the production cost is relatively low, the product made by DMT process has been commercialized.

In PTA process the copolyester containing naphthalene ring structure is obtained directly from esterification reaction, and the production cost is relatively high.

However, if 2,6-naphthalenedicarboxylate (2,6-NDC) is used as raw material in PTA process since the melting condensation polymerization reaction speed obviously becomes slow, ester exchange reaction catalyst must be added into the raw material to increase the ester exchange reaction speed to obtain the copolyester containing naphthalene ring structure.

For example, the U.S. Pat. No. 6,551,675 has disclosed the idea of adding ester exchange reaction catalyst into the process during the final stage of direct esterification reaction to obtain the copolyester containing 5-15 mole % of naphthalene ring structure.

Besides, when the above-mentioned process is employed to produce this type of copolyester higher amount of 2,6-naphthalenedicarboxylate (2,6-NDC) must be added to the raw material during the production process so that the container made of the copolyester so obtained can sustain higher filling temperature, and can successfully pass high temperature pasteurization test. Owing to this reason the copolyester material made by the above-mentioned process requires higher production cost that also results in higher obstruction in the commercialization of the copolyester.

In addition, since the conventional polyester container is made of homopolymer or random polymer containing the copolymerized monomer such as isophthalic acid, diethylene glycol or cyclohexane dimethanol through heatsetting or non-heatsetting process; the heat resistance of the non-heatsetting type container made of the conventional polyester is not higher than 82□, while the heatsetting type container made of the conventional polyester has a heat resistance not higher than 92□.

Particularly, the non-heatsetting type polyester container made of the conventional polyester will generate distortion after filled with beverage and passing through high temperature pasteurization tunnel that causes this kind of container unable to be accepted by beverage industry.

### SUMMARY OF THE INVENTION

The present invention is to disclose a thermoplastic copolyester containing naphthalene ring structure and a production method employed in the invention by adding approximately no more than 3 mole % of 2,6-naphthalenedicarboxylate (2,6-NDC) into the production process during direct esterification of PTA. Especially, without the need of adding ester exchange reaction catalyst during condensation polymerization process the copolyester containing naphthalene ring structure is then obtained. This breakthrough created from the invention has altered the traditional concept that the reaction speed will become slow during condensation polymerization process.

The thermoplastic copolyester disclosed in the invention comprises bis-hydroxyethyl terephthalate, component containing naphthalene ring structure and diethylene glycol, and the content of the component containing naphthalene ring structure is within the range of 0.8˜3.0 mole % based on the copolyester and the content of diethylene glycol is within the range of 1.0˜2.0 mole % based on the copolyester. The inherent viscosity of the copolyester is within the range of 0.76˜0.90 dl/g. The product is especially suitable for making polyester container (or plastic bottle) with heat resisting capability over 82□ which is able to pass the high temperature pasteurization test successfully.

The polyester container (or plastic bottle) made of the copolyester of the invention can be used for packing tea, fruit juice, soft soda drink or other kinds of food, beverage or nutrient etc. The packing and filling method may adopt the manner of hot-filling, then sealed with cover and then cooling down the container or may adopt the manner of cold-filling and then passing pasteurization process. The polyester container (or plastic bottle) made of the copolyester of the invention can be made into multiple-layer or single-layer structure, and during the process of filling the polyester container modification agent such as oxygen absorbing agent, ultraviolet ray absorbing agent, ethylene absorbing agent or dyeing pigment can be added to the production process of the polyester container.

### DESCRIPTION OF THE PREFERRED EMBODIMENT

The thermoplastic copolyester of the present invention contains component with naphthalene ring structure. The method for producing the copolyester of the present invention includes using 2,6-naphthalenedicarboxylate (2,6-NDC) as raw material and without using ester exchange reaction catalyst in the condensation polymerization stage.

The copolyester of the present invention comprises bis-hydroxyethyl terephthalate, component containing naphthalene ring structure and diethylene glycol, and the content of the component containing naphthalene structure is within the range of 0.8˜3.0 mole % based on the copolyester, the content of diethylene plycol is within the range of 1.0˜2.0% mole % based on the copolyester; and the inherent viscosity of the copolyester is within the range of 0.76˜0.90 dl/g, but the most preferred method for producing the copolyester of the invention is as follows:

Pour ethylene glycol (EG) into the tank equipped with mixer, and pour 2,6-naphthalenedicarboxylate (2,6-NDC) into the mixing tank during mixing state to form mixed starch, and then by employing metering pump to feed the mixed starch into the mixing tank in which pure terephthalic acid (PTA) and ethylene glycol (EG) are already mixed, and formed mixed starch, and the stirring of the mixture of PTA and EG is continued when the mixed starch of EG and NDC is poured into the tank continuously, then continue to stir the mixed starch to make the starch formed by NDC, pure PTA and EG to form uniform starch solution.

During the aforementioned process in order to uniformly stir the starch in the starch tank, the amount of EG used must be controlled within a range of proportion of 1.05˜2.0 as based on mole ratio of NDC and pure PTA, and the time the starch staying in the starch tank must not be less than 30 minutes. Meanwhile, in order to maintain the concentration of the starch in a stable condition a starch concentration controller shall be employed for a continuous control, and it is better to keep the temperature of the starch not higher than 60□ to maintain a stable density of the starch.

Then feed the starch continuously to two esterification tanks arranged in series by employing feed pump to undergo esterification process. The inversion rate of the first esterification tank is with a range of 80˜92%, and the inversion rate of the second esterification tank is within the range of 95˜98%. The esterification temperature is within the range of 240˜270□, but most preferably shall be maintained between 250˜260□. The esterification pressure is between 2.0 kg/cm² and normal pressure but most preferably the pressured is maintained within a range of 0.1˜1.0 kg/cm². The esterification time is between 3˜8 hours, but preferably the time shall be kept between 4˜6 hours.

During the direct esterification process of the invention ethylene glycol (EG), H₂O and small amount of methyl alcohol will be generated, and are fed into distillation tower through gasification tube for separation, and than the EG collected from the bottom of the distillation tower is fed back to the esterification tank, the H₂O and small amount of methyl alcohol collected from the top of the tower is sent through pipe line to waste water treatment plant for treatment.

The monomer produced from the direct esterification as mentioned above is fed into the pre-polymerization tank through feeding pump for pre-polymerization reaction. The polymerization reaction can undergo in one or both tanks. The pre-polymerization temperature is between 260˜280□, most preferably the temperature shall be maintained between 250˜260□. The pre-polymerization pressure is set in medium level vacuum state which is below ambient pressure, the vacuum pressure is between 10˜200 mmHg. The gaseous by-product, such as ethylene glycol (EG) etc., generated in pre-polymerization is sucked by the suction pressure from the vacuum environment, and sent to cooler to change the phase into liquid. The time for completing the pre-polymerization is between 0.5˜2.0 hours.

The low grade polymer obtained from the above-mentioned pre-polymerization reaction is sent to a multiple-hole die-head by pump through a set of filter screen, and the product from the die-head is cut into amorphous resin cubes.

The amorphous resin cubes obtain from the above is then treated by the commonly known continuous type solid state polymerization equipment such as the equipment made by Buhler company in Switzerland, Sinco company in Italy or Bepex company in USA to increase the molecular weight of the resin, and increase the inherent viscosity to a level ranged between 0.76˜0.90 dl/g, however the most preferred inherent viscosity is between 0.80˜0.86 dl/g.

The resin cubes obtained from the above is then made into bottle preform by injection bottle blowing machine under the melting temperature 270˜295□, and then the bottle preform is heated by infrared ray lamp to a temperature higher than glass-transition temperature, then extend and blow the bottle preform to form polyester container (this is so called two-stage bottle making method), or directly plasticize the resin cubes by ejection extending bottle blowing machine at the melting temperature between 270˜295□, then cool down the bottle preform a short period of time, then directly blow the bottle perform into polyester container (This is called single-stage bottle making method).

The polyester container made of the copolyester of the invention has the advantages including: able to sustain the hot bottling temperature over 82□, good transparency, and lower regenerated ethylene content. The allowable hot bottling temperature of the polyester container commonly seen on the market will not exceed 82□. The polyester container made of the copolyester disclosed in the present invention can be used for packing tea, fruit juice, soft soda drink or other kind of food, beverage or nutrient etc.; The packing and filling method can adopt the manner of hot filling and sealed with cover, then cool down the filled container, or cold filling at first and then passing pasteurization process.

The polyester container made of the copolyester described in the invention can be made into single-layer or multiple-layer structure, and during the production process of the polyester container oxygen absorbing agent, ultraviolet ray absorbing agent, ethylene absorbing agent or dying pigments can be add to the process depending on the requirement.

The polyester container made of the copolyester mentioned in the invention can be used on the hot filling line immediately after container production line or used on the hot filling line for filling in the beverage several days after container production line.

In the following is an example of embodiment of the invention which is for showing the effect of the copolyester disclosed in the invention, but is not for limiting the range of claims appended herewith.

### Production of the Polyester Cubes Disclosed in the Invention

The copolyester disclosed in the invention is produced by the commonly known traditional continuous type melting polymerization equipment which equipped with a PTA starch preparation tank.

Carefully mix the ethylene glycol (EG), 2,6-naphthalenedicarboxylate (2,6-NDC) and pure terephthalic acid (PTA) together, and control the mole ratio of EG to PTA+NDC at about 1.5 to obtain uniformly mixed solution, and continuously feed the starch solution to esterification tank to undergo esterification in the two tanks arranged in series. The inversion rate of the first esterification tank is about 85%, and the inversion rate of the second esterification tank is about 96%; after completion of the above-mentioned esterification process the esterified monomer is continuously fed into the pre-polymerization tank with low degree of vacuum; polymerization catalyst and pigments etc. are added into the starch before feeding into the pre-polymerization tank; It needs about 30˜60 min. to form pre-polymer, and then the pre-polymer is continuously fed into the main polymerization tank by pump with high vacuum pressure. Normally the highest degree of vacuum is that the pressure must be lower than 1 mm Hg. Owing to this reason the main polymerization must be carried out in two reaction tanks arranged in series. The reaction temperature of the main polymerization is between 280˜290□. The reaction time is about 1.5˜3 hours; when the inherent viscosity of the polymer reaches 0.55 dl/g or higher than 0.55 dl/g; the polymer is carried to the extrusion mold plate, and is formed into strips through the holes on the mold plate. The hot strips of copolyester are then cold down with chilled water and cut into cubes.

The amorphous copolyester cubes obtained from melting polymerization process is then processed by the commonly known traditional continuous type solid state polymerization equipment to increase its inherent viscosity to the desired degree of polymerization.

The so called continuous type solid state polymerization equipment including the equipment made by Buhler company in Switzerland, Sinco company in Italy, Bepex company in the USA or Zimmer company in German.

### Equipment for Producing Polyester Container

The copolyester disclosed in the invention can be made into amorphous transparent bottle with volume of 0.6 liter and 2.0 liters approximately by employing the single-stage ejection bottle blowing machine made by AOKI Company in Japan. The melting temperature of the ejection bottle blowing machine is between 280˜295□. The melting polymer is then made into bottle preform after ejected into the cavity of forming mold, however the temperature of the polymer inside the mold cavity is still higher than the glass transition temperature after cooling. When the bottle preform is cooled down to lower temperature the bottle will become even harder with higher transparency. However, if the temperature of the bottle preform is too high, chalking and crystallization shall be resulted in before bottle blowing.

When the copolyester disclosed in the invention is used for producing polyester container, the bottle preform must be maintained a proper softness and good transparently before carrying out bottle blowing.

### Testing Method for Verifying the Heat Resistance of the Polyester Container During Hot Bottling

Leave the polyester bottle obtained from the above under room temperature for 3 days, and then fill the bottle with hot water with temperature over 80□, then seal the bottle with cover immediately, and then leave the bottle in horizontal lying down position for 1 min., then in vertical standing position for 5 min., then the bottle is put in cold water of 10□, then check the outer appearance of the bottle for any apparent deformation, and measure the volume change rate of the bottle.

Again test the polyester bottle obtained from the above for heat resistance during hot bottling with hot water of different temperature. The heat resistant bottling temperature of the polyester bottle shall be the highest temperature of bottling under which the polyester bottle presents no any apparent deformation on outer appearance, and has a volume change rate lower than 3%.

### Test Method of High Temperature Pasteurization

Fill the polyester bottle obtained from the above with soda water having volumetric ratio of 3.0, and then seal the bottle with cover. Put the soda water contained bottle in pasteurization chamber, and sprinkle hot water of 71□ on the bottle until the temperature of the water inside the bottle reaches 63□; then decrease the hot sprinkling water temperature to 64□, and maintain the water temperature of the water inside the bottle at 63□ for about 15 min.; then decrease the sprinkling water temperature to 40□. When the temperature of the water inside the bottle is dropped down to 40□, put the polyester bottle into chilling water for rapid cooling. Then inspect the outer appearance and volume change rate of the polyester bottle after test.

The outer appearance of the polyester bottle must not present any apparent deformation, and the volume change rate must be lower than 3%. If a volume change rate is lower than 1.5%, it means excellent quality of resistance to high temperature pasteurization; if a volume change rate is between 1.5˜3%, it means average but acceptable quality of resistance to high temperature pasteurization; and if a volume change rate higher than 3.0%, it means poor quality of resistance to high temperature pasteurization of the polyester bottle.

### EXAMPLE 1

Employing the method for producing the copolyester with naphthalene ring structure as described in the invention to obtain the copolyester which, based on the copolyester, contains 0.8 mole % of 2,6-naphthalenedicarboxylate (2,6-NDC) and 1.3 mole % of diethylene glycol. The inherent viscosity of copolyester is 0.8 dl/g. The test result of a polyester bottle with volume of 0.6 liter made of the above-mentioned copolyester is shown in Table 1.

The heat resistant bottling temperature of the polyester bottle is 85□, and the polyester bottle can successfully pass the high temperature pasteurization test.

### EXAMPLE 2

Using the copolyester material same as that of example 1 but the inherent viscosity of the copolyester is increased to 0.84 dl/g.

A polyester bottle with volume of 0.6 liter made of the aforementioned copolyester is tested. The test result is shown in Table 1 which shows a heat resistant bottling temperature of 86□, and the polyester bottle can successfully pass the high temperature pasteurization test.

### EXAMPLE 3

Employing the method for producing the copolyester containing naphthalene ring structure as described in the invention to obtain the copolyester which, based on the copolyester, contains 0.8 mole % 2,6-naphthalenedicarboxylate (2,6-NDC) and 1.65 mole % of diethylene glycol. The inherent viscosity of the copolyester is 0.84 dl/g.

The test result of a polyester bottle with volume of 2.0 liter made of the above-mentioned copolyester is shown in Table 1. The heat resistant bottling temperature is 83.5□, and the polyester bottle can successfully pass the high temperature pasteurization test.

### EXAMPLE 4

Using the copolyester material same as that of Example 3 to make a polyester bottle with volume 0.6 liter. As shown in Table 1 the heat resistant bottling temperature is 85.5□, and the polyester bottle can successfully pass the high temperature pasteurization test.

### EXAMPLE 5

Employing the method for producing the copolyester with naphthalene ring structure as described in the invention to obtain the copolyester which, based on the copolyester, contains 0.8 mole % of 2,6-naphthalenedicarboxylate (2,6-NDC) and 2.0 mole % of diethylene glycol. The inherent viscosity of the copolyester is 0.84 dl/g.

The test result of a polyester bottle with volume of 0.6 liter made of the above-mentioned copolyester is shown in Table 1. The heat resistant bottling temperature of the polyester bottle is 84.5□, and the polyester bottle can successfully pass the high temperature pasteurization test.

### EXAMPLE 6

Employing the method for producing the copolyester containing naphthalene ring structure as described in the invention to obtain the copolyester which, based on the copolyester, contains 1.5 mole % of 2,6-naphthalenedicarboxylate (2,6-NDC) and 1.59 mole % of diethylene glycol. The inherent viscosity of the copolyester is 0.90 dl/g.

The test result of a polyester bottle with volume of 2.0 liters made of the above-mentioned copolyester is shown Table 1. The heat resistant bottling temperature of the polyester bottle is 85.5□, and the bottle can successfully pass the high temperature pasteurization test.

### EXAMPLE 7

Employing the method for producing the copolyester containing naphthalene ring structure as described in the invention to obtain the copolyester which, based on the copolyester, contains 3.0 mole % of 2,6-naphthalenedicarboxylate (2,6-NDC) and 1.57 mole % of diethylene glycol. The inherent viscosity of the copolyester is 0.80 dl/g.

The test result of a polyester bottle with volume of 0.6 liter made of the above-mentioned copolyester is shown in Table 1. The heat resistant bottling temperature is 85.1□ and the bottle can successfully pass the high temperature pasteurization test.

### EXAMPLE 8

Employing the method for producing the copolyester containing naphthalene ring structure as described in the invention to obtain the copolyester, but with the inversion rate in the esterification stage decreased so that, as based on the copolyester, the content of diethylene alycol is 1.0 mole %, and the content of 2,6-naphthalenedicarboxylate (2,6-NDC) is 2.0 mole %, and the inherent viscosity of the copolyester is 0.76 dl/g.

The test result of a polyester bottle with volume of 2.0 liters made of the above-mentioned copolyester is shown in Table 1. The heat resistant bottling temperature is 84.0□, and the bottle can successfully pass the high temperature pasteurization test.

### COMPARISON EXAMPLE 1

Employing the method for producing the copolyester containing naphthalene ring structure as described in the invention to obtain the copolyester which, based on the copolyester, contains 5.12 mole % of 2,6-naphthalenedicarboxylate (2,6-NDC) and 1.50 mole % of diethylene glycol. The inherent viscosity of the copolyester is 0.87 dl/g.

The test result of a polyester bottle with volume of 0.6 liter made of the afore-mentioned copolyester is shown in Table 1. The heat resistant bottling temperature is 85.5□, and the bottle can successfully pass the high temperature pasteurization test, but the raw material cost for producing the bottle product is obviously higher than that made of the copolyester disclosed by the invention.

### COMPARISON EXAMPLE 2

Employing the method for producing the copolyester containing naphthalene ring structure as described in the invention which, based on the copolyester, contains 0.8 mole % of 2,6-naphthalenedicarboxylate (2,6-NDC) and 1.65 mole % of diethylene glycol. The inherent viscosity of the copolyester is 0.76 dl/g.

The test result of polyester bottle with volume of 2.0 liters made of the afore-mentioned copolyester is shown in Table 1. The heat resistant bottling temperature is only 82□, and the volume change rate of the bottle after high temp pasteurization test is 2.5% which is little higher than the desired value, and shows that lower inherent viscosity will result in lower heat resistant bottling temperature of copolyester.

### COMPARISON EXAMPLE 3

Employing the method for producing the copolyester containing naphthalene ring structure as described in the invention which, based on the copolyester, contains 0.8 mole of 2,6-naphthalenedicarboxylate (2,6-NDC) and 2.36 mole % of diethylene glycol. The inherent viscosity of the copolyester is 0.80 dl/g.

The test result of a polyester bottle with volume of 0.6 liter made of the aforementioned copolyester is shown in Table 1. The heat resistant bottling temperature is only 83.0□, and the volume change rate after high temperature pasteurization test is 2.8% which is a little higher than the desired value, and shows that when the content of diethylene glycol exceeds the range of content proposed in the present invention the copolyester is unable to provide the effect described in the invention.

### COMPARISON EXAMPLE 4

Prepare a homopolymer containing only 1.70 mole % of diethylene glycol, and the inherent viscosity of the homopolymer is just 0.84 inch dl/g.

The test result of a polyester bottle with volume of 2.0 liters made of the homopolymer is shown in Table 1. The heat resistant bottling temperature is just 81.0□, but the bottle can successfully pass the high temperature pasteurization test.

### COMPARISON EXAMPLE 5

Prepare a copolyester containing 0.5 mole % of isophthalic acid and 1.85 mole % of diethylene glycol, and the inherent viscosity of the copolyester is 0.80 dl/g.

The test result of a polyester bottle with volume of 2.0 liters made of the aforementioned copolyester is shown in Table 1. The heat resistant bottling temperature is just 80.5□, and the polyester bottle failed in the high temperature pasteurization test.

### COMPARISON EXAMPLE 6

Prepare a copolyester containing 1.80 mole % of isophthalic acid and 1.85 mole % diethylene glycol, and the inherent viscosity of the polyester is 0.86 dl/g.

The test result of a polyester bottle with volume of 0.6 liter made of the aforementioned copolyester is shown in Table 1. The heat resistant bottling temperature is just 82.3□, and the polyester bottle failed in the high temperature pasteurization test.

### COMPARISON EXAMPLE 7

Prepare a copolyester containing 1.80 mole % isophthalic acid and 1.85 mole % of diethylene glycol, and the inherent viscosity of the copolyester is 0.86 dl/g.

The test result of a polyester bottle with volume of 2.0 liters made of the aforementioned copolyester is shown in Table 1. The heat resistant bottling temperature is just 80.0□, and the polyester bottle failed in the high temperature pasteurization test.

TABLE 1

| | Item | | | | | | | | |
|---|---|---|---|---|---|---|---|---|---|
| | | | | | | | Melting | Heat resistant | High temp. |
| | IPA | NDC | DEG | IV | | | injection | bottling temp. □ | pasteurization |
| Example | mol % | mol % | mol % | dl/g | Tg □ | Tm □ | temp. □ | (Volume of bottle) | test |
| Example 1 | 0 | 0.8 | 1.30 | 0.80 | 82.87 | 242.7 | 295~300 | 85.5□ | good |
| | | | | | | | | (0.6 L) | |
| Example 2 | 0 | 0.8 | 1.30 | 0.84 | 82.87 | 242.7 | 295~300 | 86.0□ | good |
| | | | | | | | | (0.6 L) | |
| Example 3 | 0 | 0.8 | 1.65 | 0.84 | 82.56 | 242.3 | 295~300 | 83.5□ | good |
| | | | | | | | | (2.0 L) | |
| Example 4 | 0 | 0.8 | 1.65 | 0.84 | 82.56 | 242.3 | 295~300 | 85.5□ | good |
| | | | | | | | | (0.6 L) | |
| Example 5 | 0 | 0.8 | 2.00 | 0.84 | 82.33 | 241.3 | 295~300 | 84.5□ | good |
| | | | | | | | | (0.6 L) | |
| Example 6 | 0 | 1.5 | 1.59 | 0.90 | 84.53 | 237.0 | 285~290 | 85.5□ | good |
| | | | | | | | | (2.0 L) | |
| Example 7 | 0 | 3.0 | 1.57 | 0.80 | 85.12 | 236.4 | 285~290 | 85.1□ | good |
| | | | | | | | | (0.6 L) | |
| Example 8 | 0 | 2.0 | 1.0 | 0.76 | 85.50 | 241.0 | 290~295 | 84.0□ | good |
| | | | | | | | | (2.0 L) | |
| Comparison | 0 | 5.12 | 1.50 | 0.87 | 85.60 | 236.0 | 275~280 | 85.5□ | good |
| Example 1 | | | | | | | | (0.6 L) | |
| Comparison | 0 | 0.8 | 1.65 | 0.76 | 82.56 | 242.3 | 295~300 | 82.0□ | average |
| Example 2 | | | | | | | | (2.0 L) | |
| Comparison | 0 | 0.8 | 2.36 | 0.80 | 81.00 | 241.5 | 295~300 | 83.0□ | average |
| Example 3 | | | | | | | | (0.6 L) | |
| Comparison | 0 | 0 | 1.70 | 0.84 | 80.00 | 251 | 305 | 81.0□ | good |
| Example 4 | | | | | | | | (2.0 L) | |
| Comparison | 0.5 | 0 | 1.85 | 0.80 | 79.70 | 247 | 300~305 | 80.5□ | poor |
| Example 5 | | | | | | | | (2.0 L) | |
| Comparison | 1.80 | 0 | 1.85 | 0.86 | 79.00 | 243 | 295~300 | 82.3□ | poor |
| Example 6 | | | | | | | | (0.6 L) | |
| Comparison | 1.80 | 0 | 1.85 | 0.86 | 79.00 | 243 | 295~300 | 80.0□ | poor |
| Example 7 | | | | | | | | (2.0 L) | |

The content of each individual component shown in Table 1 is based on the copolyester.

What is claimed is:

1. A copolyester for producing polyester container capable to sustain a hot bottling temperature at least higher than 82□, comprising bis-hydroxyethyl terephthalate, component containing naphthalene ring structure and diethylene glycol, wherein the content of the component containing naphthalene ring structure is within the range of 0.8˜3.0 mole % based on the copolyester and the content of the diethylene glycol is within the range of 1.0˜2.0 mole % based on the copolyester; and the inherent viscosity of the copolyester is within the range of 0.76˜0.90 dl/g.

2. The copolyester as described in claim 1, wherein the inherent viscosity of the copolyester is within the range of 0.80˜0.86 dl/g.

3. The copolyester as described in claim 1, wherein the component with naphthalene ring structure is 2,6-naphthalenedicarboxylate (2,6-NDC).

4. The copolyester as described in claim 2, wherein the component with naphthalene ring structure is 2,6-naphthalenedicarboxylate (2,6-NDC).

5. The copolyester as described in claim 1, which is produced by adding 2,6-naphthalenedicarboxylate (2,6-NDC) in the production process of pure isophthalic acid (PTA) method.

6. A polyester container made of the copolyester of claim 1 and produced by employing injection bottle blowing machine, wherein the polyester container is capable to sustain a hot bottling temperature at least higher than 82□.

7. The polyester container as described in claim 6, which structure is provided with single layer or multiple layer for packing tea, fruit juice, soft soda drink, food or nutrient.
